(19) United States
(12) Patent Application Publication
(10) Pub. No.: US 2012/0062462 A1
(43) Pub. Date: Mar. 15, 2012

(54) MOUSE PAD WITH ACCOMMODATING STRUCTURE

(75) Inventors: Yin-Yu Lin, Taipei Hsien (TW); Po-Jen Shih, Taipei Hsien (TW); Sue-Yi Chen, Taipei Hsien (TW)

(73) Assignee: GIGA-BYTE TECHNOLOGY CO., LTI

(21) Appl. No.: 12/879,116

(22) Filed: Sep. 10, 2010

(51) Int. Cl. G06F 3/033; G09G 5/08

(52) U.S. Cl. 345/163

(57) ABSTRACT

A mouse device pad with accommodating structure includes a mouse pad body and a plurality of fasten members, wherein the fasten members are positioned respectively at each side edge of the body's right/wrong side, and the fasten members are corresponding to one another for bonding together, such that when the fasten members are corresponding to the other ones for bonding together, the mouse pad body are bended to form an accommodated room within the mouse pad body.

### BACKGROUND OF THE INVENTION

1. Field of the Invention

The present invention relates to a mouse pad with accommodating structure, and more particularly, to a mouse pad for accommodating computer mouse therein.

2. Description of the Prior Art

With the ages progress, computers are widespread increasingly. More and more people carry notebook computers with them to deal with work at any time for the purpose of convenience. A mouse is used as a computer input device to control the movement of a cursor on a video display connected to the computer. As for notebook computers, cursor location is controlled by response to the movement of the finger across a touch panel. However, most of people are not familiar with such touch operation because they get used to handle the computer by means of a mouse. And the accuracy of the movement of finger is not as good as the operation on the hand-held mouse. As a result, most of people tend to carryon mouse device additionally when taking notebook computer outside.

FIG. 1 is the diagram of a conventional notebook computer connected with mouse device, which illustrates the way of notebook computer 1 connecting with mouse device 2. However, the current mouse device 2 is generally optical mouse which requires a perfect flat surface for placing mouse operating thereon. The optical mouse is unable to control the movement of cursor exactly when placed on such as flat surface of bad reflectivity or glass surface, which reduce efficiency of operations greatly. Thus the user needs to carryon a mouse pad 3 additionally for the purpose of providing a suitable operating flat surface required for optical mouse, which is inconvenient for the user that carryon mouse 2 together with mouse pad 3. Therefore integrating mouse 2 and mouse pad 3 together leads to convenience for carryon.

### SUMMARY OF THE INVENTION

The primary objective of the invention herein is to provide a kind of improved mouse device pad with accommodating structure for integrating mouse and mouse pad together by accommodating computer mouse in mouse pad, which improved carrying convenience.

To achieve the aforementioned objective, the present invention provides a mouse device pad with accommodating structure, including a mouse pad body and a plurality of fasten members, wherein the fasten members are positioned respectively at each side edge of the body's right/wrong side, and the fasten members are corresponding to one another for bonding together, such that when the fasten members are corresponding to the other ones for bonding together, the mouse pad body are bended to form an accommodated room within the mouse pad body.

As described in one embodiment, the mouse device pad with accommodating structure further includes a grooved rim disposed along each edge of the body's right/wrong side, where the fasten members are positioned thereon.

Preferably, the mouse device pad with accommodating structure further includes: the fasten members positioned on the right/wrong side of the mouse pad body are one-batch formed.

Preferably, the fasten members are shaped as button, velcro, or zipper.

Preferably, the fasten members is provided with a cable-accepting member.

Preferably, the cable-accepting member and the fasten member are one-batch formed.

### BRIEF DESCRIPTION OF THE DRAWINGS

FIG. 1 shows the notebook computer connected to a mouse device of the prior art;

FIG. 2A shows the mouse pad with accommodating structure according to the present invention;

FIG. 2B is the enlarged view of the second fasten member according to the present invention;

FIG. 3A shows the mouse pad when accommodated with a mouse therein;

FIG. 3B shows the mouse pad according to the other embodiment when accommodated with a mouse therein;

FIG. 3C shows the mouse pad according to the other embodiment when accommodated with a mouse therein.

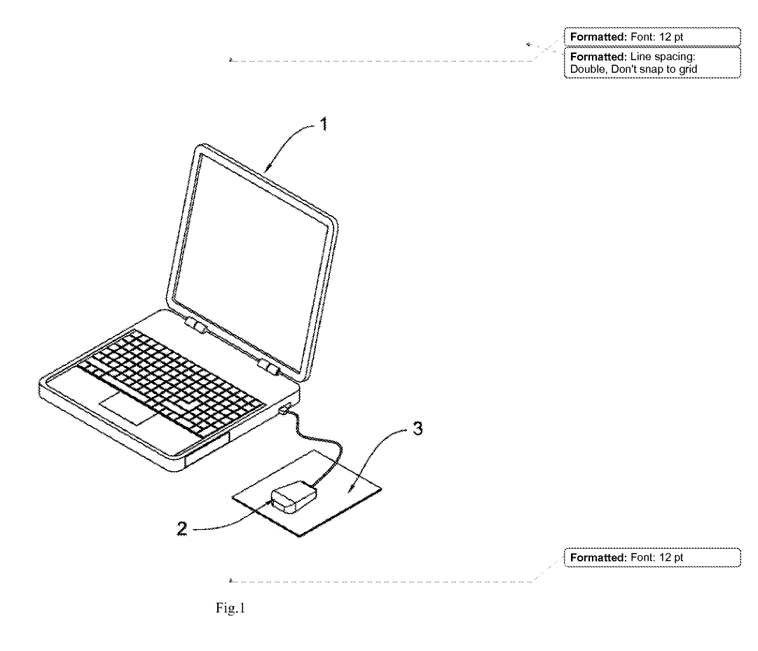

### DETAILED DESCRIPTION OF THE INVENTION

The aforementioned objects and advantages of the present invention will be more fully understood hereinafter as a result of a detailed description when taken in conjunction with the following drawings in which:

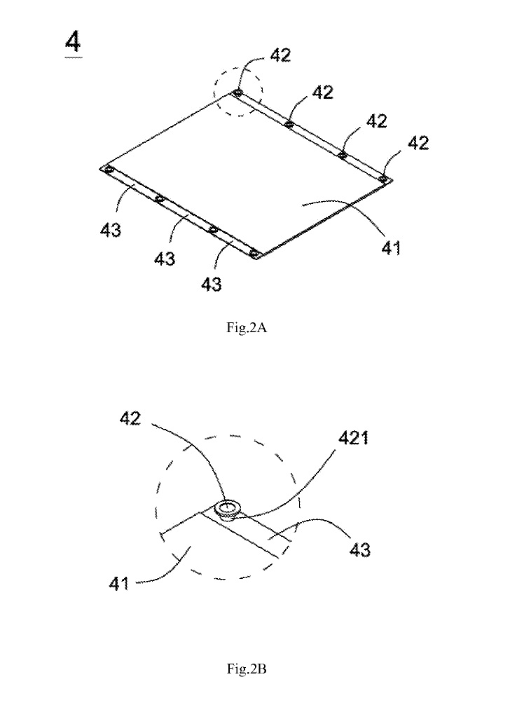

FIG. 2A shows the mouse pad with accommodating structure according to the present invention. The mouse device pad 4 with accommodating structure includes a mouse pad body 41 and a plurality of fasten members 42, wherein the fasten members 42 are positioned respectively at both side edges of the right/wrong side of the mouse pad body 41. The numbers and configuration of the fasten members 42 according to the present invention are not limited. There is a grooved rim 43 disposed along each edge of both the right/wrong side of the mouse pad body, in which the fasten members 42 are positioned therein, such that the fasten members 42 do not protrude out of both the right/wrong side of the mouse pad body 41. FIG. 2B is the enlarged view of the second fasten member according to the present invention. The fasten member 42 is provided with a cable-accepting member 421, which aims to wind the connecting cable of the mouse 2 and accept the cable therein. The cable-accepting member 421 can be positioned on any one of the fasten members 42 or not limited according to the present invention.

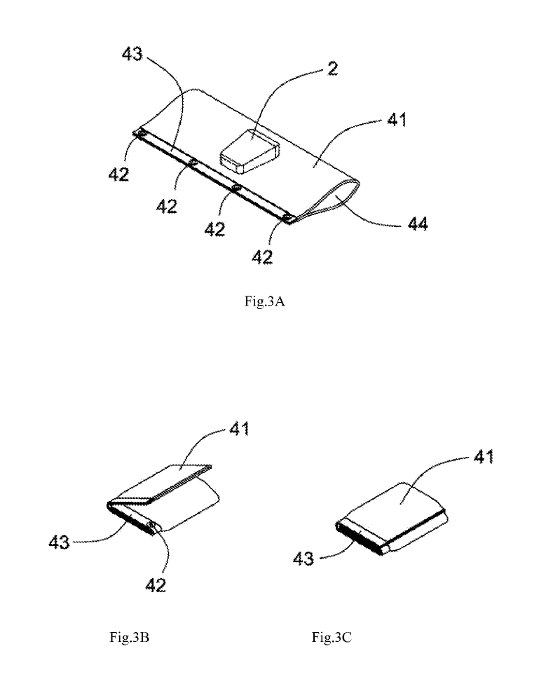

Referring now to FIG. 3A, FIG. 3A shows the mouse pad when accommodated with a mouse therein. The fasten member 42 is corresponding to the other one 42 for bonding together, to make the mouse pad body 41 forming a folded structure, such that an accommodating room 44 formed within the mouse pad body 41 which is applied to accommodating a mouse device 2 or other content object that is not limited according to the present invention. The fasten members 42 positioned oppositely on both the right/wrong side of the mouse pad body 41 are one-batch formed, which are mounted through each side edge of the mouse pad body 41. FIG. 3B shows the mouse pad according to the other embodiment when accommodated with a mouse therein. The mouse pad body 41 is bended continuously in accordance with the content object contained in the accommodating room 44, in this case, either of the side edge of the mouse pad body 41 is bended each other to make the fasten member 42 be corresponding to the other one 42 for bonding together. FIG. 3C shows the mouse pad according to the other embodiment when accommodated with a mouse therein. When the fasten members 42 are bonded together, the side edge of the right/wrong side of the mouse pad body 41 is mutually folded, such that the content object contained in the accommodating room 44 is covered by the mouse pad body 41 exactly. Preferably, the fasten members are shaped as button, velcro, or zipper. The bonding position of the fasten members 42 can be adjusted on the basis of the content object in the accommodating room 44.

Although the invention has been described in detail with reference to multiple embodiments, additional variations and modifications exist within the scope and spirit of the invention as described and defined in the following claims.

What is claimed is:

1. A mouse pad with accommodating structure, comprising:
a mouse device body; and
a plurality of fasten members, which are positioned respectively at each side edge of the body's right/wrong side, and are corresponding to one another for bonding together;
wherein when the fasten members are corresponding to the other ones for bonding together, the mouse pad body are bended to form an accommodated room within the body.

2. A mouse device pad with accommodating structure as described in claim 1, also comprising a grooved rim disposed along each edge of the body's right/wrong side, where the fasten members are positioned thereon.

3. A mouse device pad with accommodating structure as described in claim 1, wherein said fasten members positioned on the body's right/wrong side are one-batch formed.

4. A mouse device pad with accommodating structure as described in claim 1, wherein said fasten members are shaped as button, velcro, or zipper.

5. A mouse device pad with accommodating structure as described in claim 1, wherein said fasten member is provided with a cable-accepting member.

6. A mouse device pad with accommodating structure as described in claim 5, wherein said cable-accepting member and said fasten member are one-batch formed.
